(19) United States
(12) Patent Application Publication
(10) Pub. No.: US 2008/0076454 A1
(43) Pub. Date: Mar. 27, 2008

(54) METHOD AND SYSTEM OF FORMING A WLAN FOR A DUAL MODE CELLULAR DEVICE

(75) Inventor: Chih-hao Yeh, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/534,769

(22) Filed: Sep. 25, 2006

(51) Int. Cl. H04Q 7/20

(52) U.S. Cl. 455/466

(57) ABSTRACT

A method of forming a WLAN for a dual mode cellular device is provided, comprising a handset sending a notification to a cellular network, the cellular network responds a message comprising WLAN setup information to the handset, the handset receiving and applying the message to set up a WLAN interface using the WLAN setup information, and the handset connecting to an access point using the WLAN interface, thereby forming a WLAN

### BACKGROUND OF THE INVENTION

1. Field of the Invention

The present invention relates to a dual mode network, and in particular to a method and system of forming a wireless local area network (WLAN) for a dual mode cellular device.

2. Description of the Related Art

Global System for Mobile Communications (GSM)/General Packet Radio Service (GPRS) cellular phones have been widely used in the public but applications for GSM/GPRS phones may be restricted to traditional voice service. The data service is not as popular as was expected, except for short message service (SMS). With the rapid growth of WLAN, more access points are deployed in public areas for user service while more users connect to the Internet through wireless devices. Convergence of WLAN and cellular networks accessible by WLAN/Cellular dual mode handsets will lead to more convenience and efficiency for end users in selecting the correct network according to the user environment. In such an integrated environment, user authentication, billing, and user management are very important issues.

For most users, setting up WLAN is complicated as either an independent basic service set (IBSS) or a basic service set (BSS), in which users are required to input a service set ID (SSID), a 802.11 wired equivalent privacy (WEP) key, a Wi-Fi protected access (WPA) passphrase, IP information, and so forth. Additionally, it is even more complicated to set up a WLAN interface in a dual mode handset due to the smaller screen, small keypad, and less powerful processor. Further, joining a WLAN hot spot is also difficult as most hot spots (public access points) request a login name and a password on a designated web page before allowing access to the Internet.

A U.S. Pat. No. 6,9040,55 discloses “Ad hoc networking of terminals aided by a cellular network”. The disclosure cites a method for ad hoc networking of terminals over a non-cellular interface aided by a cellular network, comprising, determining the identities of the terminals desiring to establish an ad hoc link, determining a network associated with the terminals, choosing a signaling transport method for the terminals, establishing a secure connection between the terminals with the aid of the cellular network, receiving update information relating to the terminals, and forming a description of an ad hoc network in response to receiving the update information.

The disclosure further describes a system for ad hoc networking of terminals aided by a cellular network, comprising terminals. The terminals include an interface unit arranged to communicate with a cellular network and a central register. The cellular network is configured to communicate with terminals, determine the identity of the terminals that desire to establish an ad hoc link, determine a network associated with the terminals, choose a signaling transport for the terminals, and establish a secure link with the terminals. The central register is configured to receive update information relating to the terminals and is further configured to form a description of an ad hoc network in response to receiving the update information.

A U.S. patent (No. 2004/0233893) discloses a system and method for transferring wireless network access passwords, comprising: providing an access node, comprising a first interface for sending and receiving communication of a first type to and from a first node operating in a wireless local area network (WLAN), a second interface for sending and receiving communication of a second type to and from a second node in a wireless network, and a short messaging service (SMS) module for sending and receiving SMS messages to the second node.

The disclosure further discloses a method for providing a one-time password (OTP) for accessing a wireless local area network (WLAN), comprising sending a first SMS message to a mobile station operating in a mobile network, the first SMS message including an identifier for an access node serving the WLAN, receiving a second SMS message from the mobile station into the access node, checking for a predetermined condition associated with either the mobile station or the mobile network, if the predetermined condition is met, providing the OTP to the mobile station, and providing a WLAN service to the WLAN client upon receipt of the OTP.

The disclosure further discloses a method for providing access to a WLAN, the method comprising sending a first message to a mobile station operating in a mobile network, the first message including an identifier for an access node serving the WLAN, receiving a second message from the mobile station so that the access node can provide an access code for use with the second network, and receiving the access code from the access node in a third message, whereby the WLAN can be accessed using the access code.

The disclosure further discloses a method for providing a password to a WLAN client for using a wireless local area network (WLAN), comprising receiving an SMS message from a mobile station operating in a wireless network into an access controller serving the WLAN, checking for a predetermined condition associated with the mobile station, if the predetermined condition is met, providing the password to the mobile station, receiving an access request from the WLAN client, the access request including the password, and allowing the WLAN client to connect to an internet node.

The Pat. No. 6,904,055 establishes secure links using cellular operator-controlled devices and enables an operator to be involved in local traffic exchange that bypasses the infrastructure and thus offers a tool for additional revenue that would otherwise escape the operator. The patent (No. 2004/0233893) assigns and provides passwords to one or more entities to allow then to access a wireless network. Both the methods, however, do not really combine a WLAN and a cellular network to a cellular device. Additionally, when a device connects to a WLAN, WLAN setup parameters comprising a SSID, a WEP key, a WPA passphrase, IP information, a web page address, a login name, a login password, and so forth are required, but cellular devices without a browser cannot implement the input operation to connect to a WLAN.

Thus, the invention provides a method and system of forming a wireless local area network (WLAN) for a dual mode cellular device, allowing a dual-mode handset to setup a WALN interface via message service of a cellular network.

### BRIEF SUMMARY OF THE INVENTION

A method of forming a WLAN for a dual mode cellular device is provided, comprising a handset sending a notification to a cellular network, the cellular network responds a message to the handset, the handset receiving and applying the message to update WLAN setup information, and the handset connecting to an access point using the WLAN setup information, thereby forming a WLAN.

A method of forming a WLAN for a dual mode cellular device is provided, comprising a first handset sending a message to a cellular network, the cellular network forwarding the message to a second handset, the second handset receiving and applying the message to update WLAN setup information, and the second handset connecting to the first handset using the WLAN setup information, thereby forming a WLAN.

A system of forming a WLAN for a dual mode cellular device is provided, comprising an access point, a handset, and a cellular network. The handset sends a notification. The cellular network receives the notification and responds a message to the handset. The handset receives and applies the message to update WLAN setup information, and connects to the access point using the WLAN setup information.

A system of forming a WLAN for a dual mode cellular device is provided, comprising a first handset, a second handset and a cellular network. The first handset, sending a message. The cellular network, receiving and forwarding the message. The second handset receives and applies the message to update WLAN setup information and connects to the first handset using the WLAN setup information

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of an embodiment of a system of forming a WLAN for a dual mode cellular device, connecting a handset to an access point;

FIG. 2 is a schematic view of an embodiment of a system of forming a WLAN for a dual mode cellular device, connecting a first handset with a second handset;

FIG. 3 is a flowchart of an embodiment of a method of forming a WLAN for a dual mode cellular device, connecting a handset to an access point.

FIG. 4 is a flowchart of another embodiment of a method of forming a WLAN for a dual mode cellular device, connecting a first handset to a second handset.

### DETAILED DESCRIPTION OF THE INVENTION

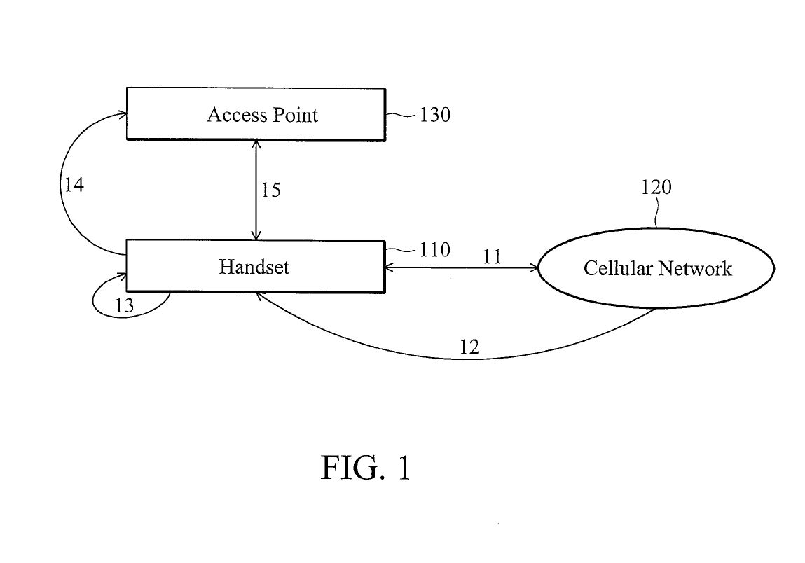

Several exemplary embodiments of the invention are described with reference to FIGS. 1 through 4, which generally relate to integrate WLAN and cellular network interfaces into a cellular device to form a WLAN for the cellular network. It is to be understood that the following disclosure provides many different embodiments as examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The invention discloses a method and system of forming a WLAN for a dual mode cellular device.

A dual mode handset is a device providing a cellular network interface and a WLAN interface, originally connecting to a cellular network and to a WLAN when required. As described, when a device connects to a WLAN, WLAN setup parameters must be input.

The invention carries the WLAN setup information in a message, such as an SMS. A handset receives the message via a cellular network interface and enters IP and login information via a WLAN interface to form a WLAN. The message can also be sent with a unique identifiable handset in cellular network.

FIG. 1 is a schematic view of an embodiment of a system of forming a WLAN for a dual mode cellular device, connecting a handset to an access point. The system comprises a handset 110 (a dual mode cellular device), a cellular network 120, and an access point 130.

When a WLAN connection is required, handset 110 first sends a notification to cellular network 120 (operation 11). Cellular network 120 sends a message to handset 110 (operation 12). The message comprises WLAN setup information, comprising a SSID, a WEP key, a WPA passphrase, IP information, a web page address, a login name, a login password, and so forth. Contents of a message are described in table 1 in the following.

TABLE 1

| ID | Element Name | Value |
|---|---|---|
| 0 | SSID | 2 digit decimal string length followed by a string |
| 1 | Frequency | 4 digit decimal in unit of k Hz, 0000 for No |
| | | information |
| 2 | Operating Mode | 0: No information 1: 802.11B 2: 802.11G, |
| | | A, or AG |
| 3 | Authentication | 0: Open 1: Shared 2: WPA 3: WPA2 |
| 4 | Key | 0: None 1: WEP 40 bit 2: WEP: 104 bit 3: TKIP |
| | | 4: AES-CCMP |
| 5 | Key material | Key Material in HEX format |
| 6 | URL | A string of URL. If empty, no login required. |
| 7 | User Name | For login |
| 8 | Password | For login |

When the message is received, handset 110 applies the message to set up (when first used) or update WLAN setup information thereof (operation 13). Next, handset 110 connects to access point 130 using the WLAN setup information (operation 14), thereby forming a WLAN and thus enabling communication between handset 110 and access point 130 (operation 15).

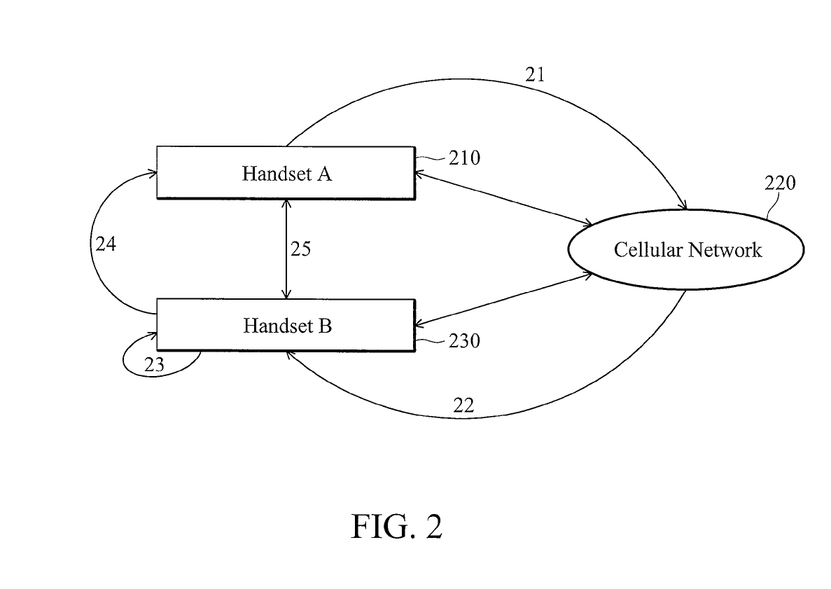

FIG. 2 is a schematic view of an embodiment of a system of forming a WLAN for a dual mode cellular device, connecting a first handset with a second handset. The system comprises a handset 210 (a dual mode cellular device), a cellular network 220, and a handset 230 (a dual mode cellular device).

Handset 210 first sends a message, comprising WLAN setup information, to cellular network 220 (operation 21). Cellular network 220 forwards the message to handset 230 (operation 22). When the message is received, handset 230 applies the message to set up (when first used) or update WLAN setup information thereof (operation 23). Next, handset 230 connects to handset 210 using the WLAN setup information (operation 24), thereby forming a WLAN and thus enabling communication between handsets 210 and 230 (operation 25).

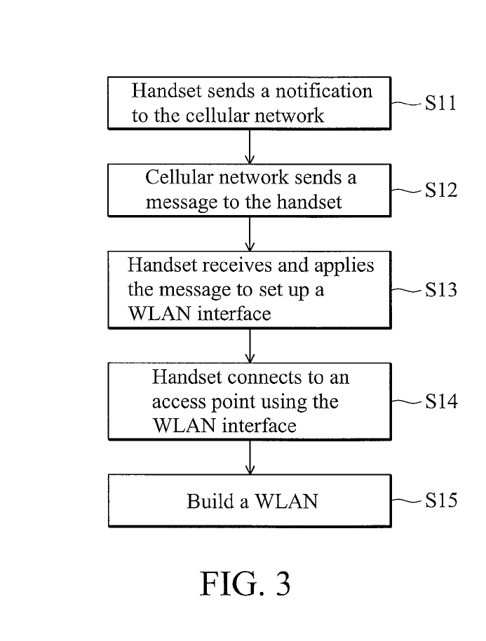

FIG. 3 is a flowchart of an embodiment of a method of forming a WLAN for a dual mode cellular device, connecting a handset to an access point.

A cellular network and a handset connecting to the cellular network are provided. The handset is a dual mode cellular device. The handset sends a notification to the cellular network when a WLAN connection is required (step S11). The cellular network sends a message to the handset (step S12). The message comprises WLAN setup information, comprising a SSID, a WEP key, a WPA passphrase, IP information, a web page address, a login name, a login password, and so forth. When the message is received, the handset applies the message to set up (when first used) or update a WLAN interface thereof using the WLAN setup information (step S13). Next, the handset connects to an access point using the WLAN interface (step S14) and a WLAN is thus formed (step S15), such that communication between the handset and the access point is enabled.

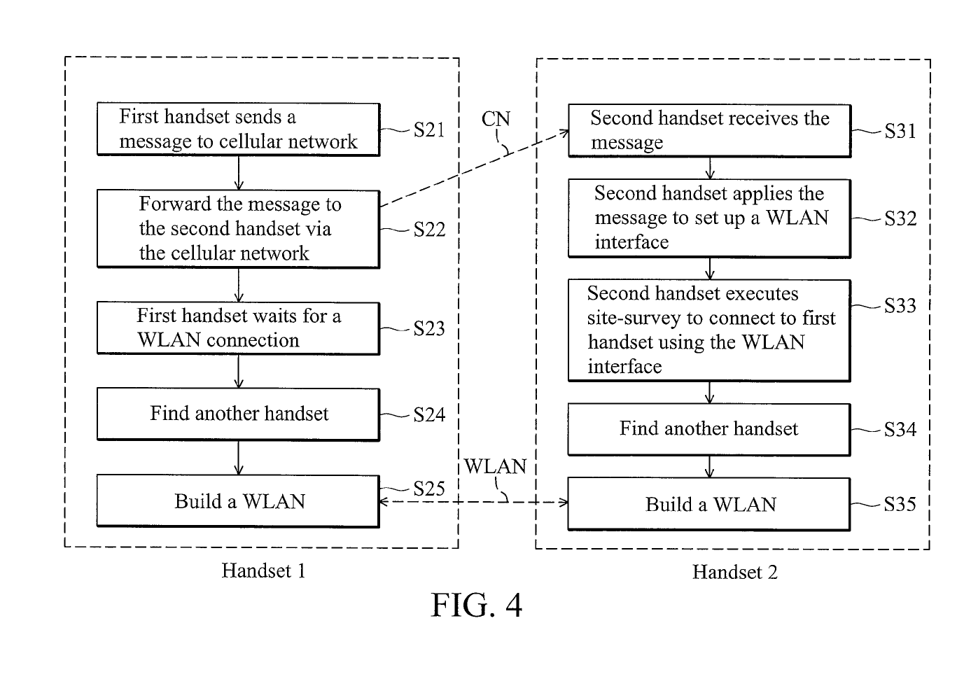

FIG. 4 is a flowchart of another embodiment of a method of forming a WLAN for a dual mode cellular device, connecting a first handset with a second handset.

A cellular network and a first handset and a second handset connecting to the cellular network are provided. The first handset and second are dual mode cellular devices. The first handset sends a message comprising WLAN configurations to the cellular network when a WLAN connection is required (step S21). The message is forwarded to the second handset via the cellular network (CN) (step S22) and then waits for a WLAN connection (step S23). The message comprises WLAN setup information, comprising a SSID, a WEP key, a WPA passphrase, IP information, a web page address, a login name, a login password, and so forth. Next, when the message is received, the second handset applies the message to set up (when first used) or update a WLAN interface thereof (steps S31 and S32). The second handset executes site-survey site survey or short message configuration to connect to the first handset using the WLAN interface (step S33). Next, the first and second handsets are found each other (steps S24 and S34) and a WLAN is thus formed (step S25 and S35), such that communication between the first and second handsets is enabled.

The following describes multiple applications for forming a WLAN of the invention.

In an application, an access point carries a telecommunication network identifier, such as a phone number. A handset dials in (sending a signal to) or sends a message to the access point. The access point then responds a message to the handset according to the telecommunication network identifier. The handset receives and applies the message to form a WLAN with the access point.

In another application, a central server maintains telecommunication network identifiers (such as a phone number) of each access point in a WLAN. A handset dials in (sends a signal to) or sends a message to the server. The server then responds a message to the handset according to a telecommunication network identifier of one access point. The handset receives, updates WLAN parameter thereof, and joins the WLAN.

In another application, with respect to non-public BSS, a service can be provided for forming a WLAN interface of a handset. The service collects default settings of all access points in the market. A handset requests and applies default setting from the access point to join a WLAN.

In another application, with respect to non-public BSS, a service can be provided for forming a WLAN interface. The service provides a WEB interface for keying in settings of an access point and a cellular network ID of a user handset. The service then sends a message with the loaded information to a handset via the cellular network. The handset receives and applies the message to join a WLAN.

In another application, a previous service can be hosted in an access point or in the Internet. A user, for example, can use other computing device with rich user interfaces (US) to access the service in an access point a first place. The handset can receive the WLAN setup parameter.

In another application, a message can carry a login uniform resource locator (URL) address of a web page, and a user name and password. A handset generates a hypertext transmission protocol (HTTP) request according to such information, and thus eliminates the need to display a web page to request user login information entered via the keypad of a handset.

The invention provides setup information for a WLAN access network to enable a handset to join or form a WLAN. Additionally, the invention provides network configuration for a handset to form its WLAN interface.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of forming a WLAN for a dual mode cellular device, comprising:
a cellular network responding a message comprising WLAN setup information to a handset when a notification is received;
the handset receiving and applying the message to set up a WLAN interface using the WLAN setup information; and
the handset connecting to an access point using the WLAN interface, thereby forming a WLAN.

2. The method of forming a WLAN for a dual mode cellular device as claimed in claim 1, wherein the cellular network responds a predefined message comprising the WLAN setup information to the handset, wherein the information comprises at least one of a SSID, a WEP key, a WPA passphrase, IP information, a web page address, a login name, and a login password.

3. A method of forming a WLAN for a dual mode cellular device, comprising:
a first handset sending a message comprising WLAN setup information to a cellular network;
the cellular network forwarding the message to a second handset;
the second handset receiving and applying the message to set up a WLAN setup interface using the WLAN setup interface; and
the second handset connecting to the first handset using the WLAN setup information, thereby forming a WLAN.

4. The method of forming a WLAN for a dual mode cellular device as claimed in claim 3, wherein the first handset sends a predefined message comprising the WLAN setup information to the cellular network, wherein the information comprises at least one of a SSID, a WEP key, a WPA passphrase, IP information, a web page address, a login name, and a login password.

5. A system of forming a WLAN for a dual mode cellular device, comprising:
an access point;
a handset, sending a notification;
a cellular network, receiving the notification and responding a message comprising WLAN setup information to the handset;
wherein the handset receives and applies the message to set up a WLAN interface using the WLAN setup information, and connects to the access point using the WLAN interface.

6. The system of forming a WLAN for a dual mode cellular device as claimed in claim 5, wherein the message is predefined and comprises the WLAN setup information, comprising at least one of a SSID, a WEP key, a WPA passphrase, IP information, a web page address, a login name, and a login password.

7. A system of forming a WLAN for a dual mode cellular device, comprising:
a first handset, sending a message comprising WLAN setup information;
a cellular network, receiving and forwarding the message;
a second handset, receiving and applying the message to set up a WLAN interface using the WLAN setup information, and connects to the first handset using the WLAN interface.

8. The system of forming a WLAN for a dual mode cellular device as claimed in claim 1, wherein the message is predefined and comprises the WLAN setup information, comprising at least one of a SSID, a WEP key, a WPA passphrase, IP information, a web page address, a login name, and a login password.

9. A method of forming a WLAN for a dual mode cellular device, comprising:
a handset receiving and applying a short message to set up a WLAN interface using WLAN setup information provided by the short message; and
the handset connecting to an access point using the WLAN interface, thereby forming a WLAN.

10. The method of forming a WLAN for a dual mode cellular device as claimed in claim 1, wherein the cellular network responds a predefined message comprising the WLAN setup information to the handset, wherein the information comprises at least one of a SSID, a WEP key, a WPA passphrase, IP information, a web page address, a login name, and a login password.

11. A device, comprising;
means for responding a message comprising WLAN setup information to the handset;
means for receiving and applying the message to set up a WLAN interface using the WLAN setup information; and
means for connecting to an access point using the WLAN interface, thereby forming a WLAN.

12. A device, comprising:
means for receiving and applying a short message to set up a WLAN interface using WLAN setup information provided by the short message; and
means for connecting to an access point using the WLAN interface, thereby forming a WLAN.

13. A device, comprising:
means for sending a message comprising WLAN setup information to a cellular network;
means for forwarding the message to a second handset;
means for receiving and applying the message to set up a WLAN setup interface using the WLAN setup interface; and
means for connecting to the first handset using the WLAN setup information, thereby forming a WLAN.

14. A method of forming a WLAN for a dual mode cellular device, comprising:
the handset receiving and applying the message to set up at least one of parameters of the handset.

15. The method of forming a WLAN for a dual mode cellular device as claimed in claim 14, wherein the parameter comprise an address.
